(19) United States
(12) Patent Application Publication
(10) Pub. No.: US 2017/0165910 A1
(43) Pub. Date: Jun. 15, 2017

(54) MULTI-MATERIAL DISPENSING FOR IMPROVED PROCESS EFFICIENCY IN POWDER BED ADDITIVE MANUFACTURING

(71) Applicant: HONEYWELL FEDERAL MANUFACTURING & TECHNOLOGIES, LLC, Kansas City, MO (US)

(72) Inventor: JOSEPH EUGENE DINARDO, OVERLAND PARK, KS (US)

(73) Assignee: HONEYWELL FEDERAL MANUFACTURING & TECHNOLOGIES, LLC, KANSAS CITY, MO (US)

(21) Appl. No.: 14/966,005

(22) Filed: Dec. 11, 2015

(51) Int. Cl. B29C 67/00

(52) U.S. Cl. CPC B29C 67/0074; B29C 67/0088; B33Y 10/00

(57) ABSTRACT

An apparatus and method for additive manufacturing components. Build powder is deposited on a build platform in accordance with CAD data, and surrogate powder is deposited in regions where the build powder is not located in order to conserve build powder. An energy source traces over the build powder fusing the build powder into a first layer of the component. The build platform is then lowered so that another layer of powder may be deposited on top of the first layer. This process is repeated until a final component is completed. The surrogate powder is then removed; thus, conserving build powder.

### BACKGROUND

Additive manufacturing is a method used for producing geometrically complex components. This type of manufacturing utilizes directed energy to melt powder that is deposited on a platform. A first layer of powder is uniformly deposited on the build platform, and then the directed energy melts a first layer of the component. Then another layer of powder is uniformly deposited onto the first layer. The directed energy fuses this layer to the first layer. This process is repeated until a three-dimensional component is complete. Once the process is complete, the component is removed from the build platform, and the remaining powder left and not melted on the build platform is ideally recycled to be used again for another part. However, the recycling of the unused powder is often time-consuming, tedious, and labor intensive. It currently requires a manual reclamation of the powder via vacuuming or sweeping. The powder must then go through a sifting process in sieves in an attempt to ensure that no large particulates were collected in the vacuuming or sweeping. Then the powder is reloaded into an additive manufacturing machine to be used again to build another component. The additional and costly labor required to recycle the powder is typically substantial in relation to the operation time and cost incurred by the additive manufacturing machine. Additionally, the additive manufacturing machine cannot be used during the recycling process, so the turn-around time for an additive manufacturing machine is increased, allowing for fewer components to be made in a given period of time.

Another disadvantage of current systems and methods of additive manufacturing is the quality of recycled powder. The quality of an additively manufactured component is directly related to the quality of the powder. It is wasteful to throw unused powder away, but often the quality of the recycled powder is diminished after going through the additive manufacturing process and recycling. Each time the powder is recycled, the recycled powder's size distribution, chemistry, and morphology are inferior compared to the original powder. It is currently unknown how many times powder can be recycled before its quality is decreased to the point that it cannot be used again. This raises concerns with respect to the ability to use recycled powder for critical components. Thus, additive manufacturing for these types of applications may require additional, stringent powder recycling procedures, such as recertification of any recycled powder before being reloaded into an additive manufacturing machine for subsequent use. The recertification process can be lengthy and expensive.

This background discussion is intended to provide information related to the present invention which is not necessarily prior art.

### SUMMARY

Embodiments of the present invention solve the above-mentioned problems and provide a distinct advance in the art of additive manufacturing using recycled powders. An additive manufacturing apparatus constructed in accordance with embodiments of the invention may be used in a method of additive manufacturing that does not waste powder and does not rely on a quality of powder remaining constant after being recycled several times. The method may include a step of selectively depositing various types of powder, such as build powder and surrogate powder, in separate regions on a build platform. Then the method may include a step of selectively melting the build powder, while not tracing over or melting the surrogate powder, creating a first layer of a component being formed. This process is repeated one or more times, sequentially forming and fusing a plurality of layers of the component together until the component is finished. Then the method may include a step of removing the surrogate powder from the build platform.

In some embodiments of the invention, the deposition of the powders and/or the selective melting described above may be computer-controlled in accordance with a computer-aided design (CAD) model, or other technical model or drawing. Furthermore, a plurality of components may also be simultaneously manufactured using the methods described herein. The surrogate powder may include, for example, casting sand, which is then recycled and used in subsequent additive manufacturing processes. The build powder may be any number of materials such as metals, metal alloys, ceramics, plastics, etc.

According to another embodiment of the invention, the additive manufacturing apparatus may include a powder deposition device, a build platform, a directed energy source a first actuator, a second actuator, a third actuator, and a controller. The powder deposition device may have at least two chambers and at least one nozzle for dispensing various types of powder, including a surrogate powder and a build powder. The build platform may include a horizontally-extending base and vertical-extending walls surrounding the base. The first actuator may actuate the base relative to the wall along a center axis of the base, the second actuator may actuate movement of the directed energy source relative to the build platform, and the third actuator may actuate movement of the nozzle relative to the build platform. The controller may be communicably coupled with various other components of the additive manufacturing apparatus, and may command the actuators. Specifically, the controller may command the third actuator and the powder deposition device to selectively deposit the surrogate powder and the build powder in different regions on the build platform, and then command the directed energy source and the second actuator to selectively melt only the build powder on the build platform. The selective melting is performed without fusing any surrogate powder by tracing the directed energy source over the regions on the build platform having the build powder deposited thereon, thereby forming a layer of the component. Then the controller may command the first actuator to lower the build platform relative to the wall, and may repeat the forming of another layer of the component, thus sequentially forming and fusing a plurality of layers of the component together.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### DRAWINGS

Embodiments of the present invention are described in detail below with reference to the attached drawing figures, wherein:

FIG. 1 is an apparatus in accordance with an embodiment of the present invention;

FIG. 2 is a top view of the apparatus of FIG. 1;

FIG. 3 is a perspective view of a build platform of the apparatus of FIG. 1;

FIG. 4 is a side view of a powder deposition device of the apparatus of FIG. 1, moving relative to the build platform;

FIG. 5 is a top view of the powder deposition device of FIG. 4; and

FIG. 6 is a flowchart of a method of additive manufacturing in accordance with an embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

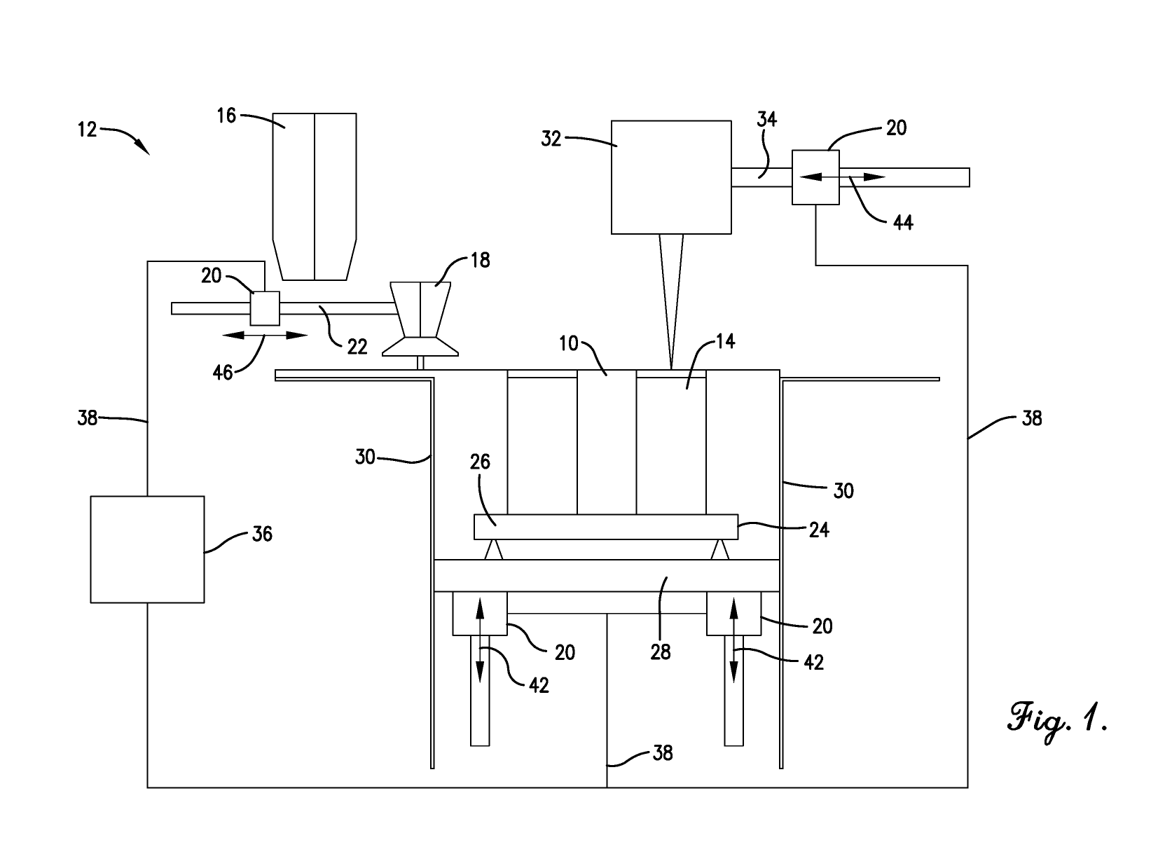

Embodiments of the invention, illustrated in FIGS. 1-6, include surrogate powder 10 used in an additive manufacturing apparatus 12 and a method 100 of additive manufacturing using the surrogate powder 10. As illustrated in FIG. 1, the additive manufacturing apparatus 12 may comprise a multi-material powder hopper 16, a plurality of actuators 20, a powder deposition device 18, a build platform 24, a directed energy source 32, and a controller 36, as described in detail below. The surrogate powder 10 may comprise any number of materials including material that has a high melting point or low melting point, or a combination of both. For example, the surrogate powder 10 may be comprised of casting sand, metal, metal alloys, carbon fiber, silicon, plastic, or other material in powder form. A build powder 14 is also used and may also be comprised of metal, metal alloys, carbon fiber, silicon, plastic, or other material in powder form. The surrogate powder 10 and build powder 14 are stored in separate compartments of a multi-material powder hopper 16, as illustrated in FIG. 1.

The multi-material powder hopper 16 may contain a plurality of types of powder, including the build powder 14 and surrogate powder 10. The powder hopper 16 may house the different types of powder in separate containers or compartments, or use walls to keep the powders separate. The powder hopper 16 also comprises a nozzle, or plurality of nozzles, through which powder is selectively supplied. The nozzle or plurality of nozzles can supply powder using solenoids, actuators, or a combination thereof. In one preferred embodiment, the nozzle, or plurality of nozzles, supply powder to a powder deposition device 18 positioned below the nozzle, or plurality of nozzles.

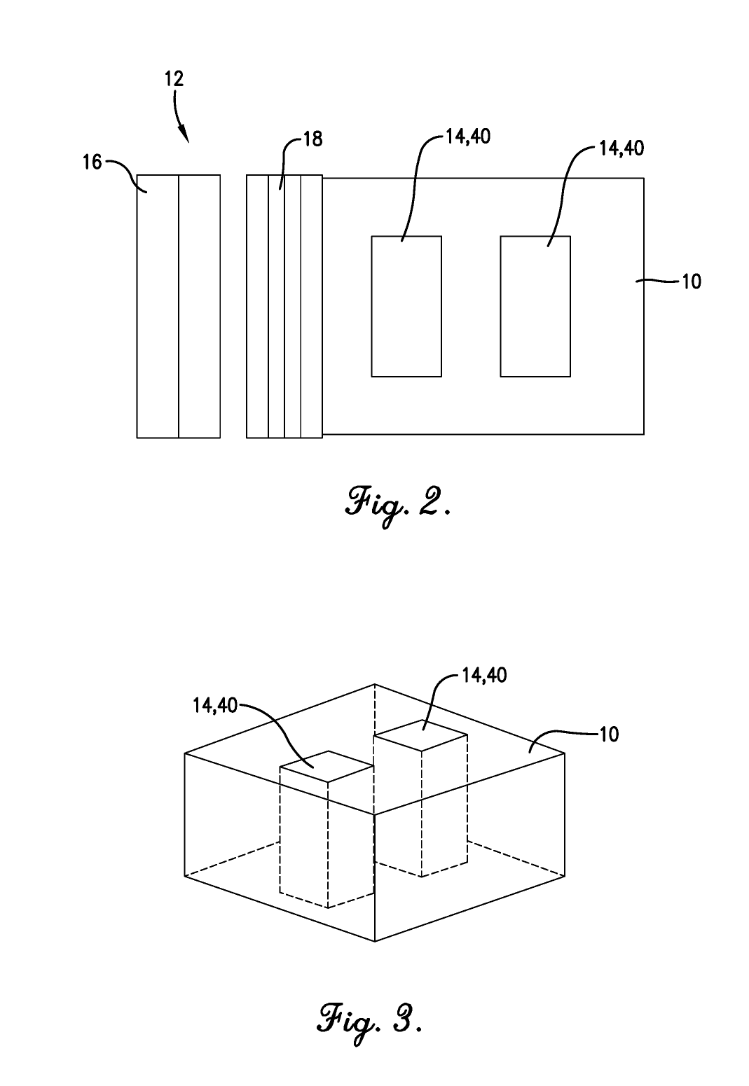

The actuators 20 may be controlled hydraulically, electrically, or manually. For example, the actuators 20 may comprise electric motors, pumps, circuits, robotic components, mechanical actuation components, hydro-mechanical components, electro-mechanical components, and the like. In some embodiments of the invention, the actuators 20 may comprise a first actuator configured to actuate travel of a portion of the build platform 24, a second actuator configured to actuate travel of the directed energy source 32 relative to the build platform 24, and a third actuator configured to actuate travel of at least a portion of the powder deposition device 18 relative to the build platform 24, as illustrated in FIG. 2. In some embodiments of the invention, the first actuator may be configured to actuate travel in directions 42 substantially perpendicular to directions 44,46 of travel provided by the second and third actuators, respectively. Furthermore, in some embodiments of the invention, the actuators may be configured to provide travel in two or more directions. Note that the actuators described herein are merely exemplary and do not limit the scope of the invention. For example, the build platform could remain stationary while only the directed energy source 32 and the deposition device 18 are actuated. Alternatively, the directed energy source 32 may remain stationary while the build platform is actuated toward and/or away from the directed energy source 32.

In some preferred embodiments of the invention, the deposition device 18 contains multiple selectively openable compartments in which it stores powder supplied by the powder hopper 16. In another preferred embodiment, the deposition device 18 contains only one powder compartment that stores the type of powder to be immediately deposited. In yet another preferred embodiment, the deposition device 18 is coupled to the hopper 16 so that it deposits the type of powder selectively supplied by the hopper 16. Furthermore, the powder deposition device 18 may comprise a nozzle, or plurality of nozzles, which may be turned on or off according to commands received by the controller 36, thereby applying a desired amount and pattern of powder on the build platform 24, as later described herein. As noted above, the nozzle or plurality of nozzles can supply powder using solenoids, actuators, or a combination thereof.

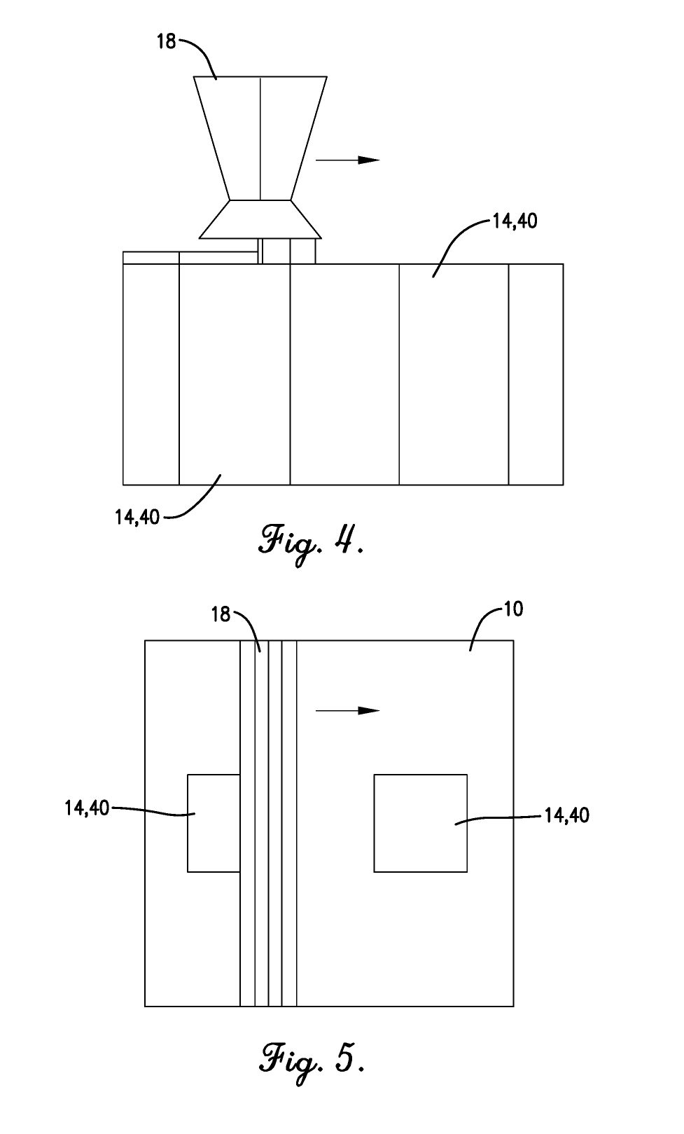

The powder deposition device 18 may comprise at least one of the actuators 20 (such as the third actuator) and/or a track 22 upon which the deposition device 18 may move to selectively deposit the powder. The actuators 20 may actuate the movement of the deposition device 18 on the track 22, moving the position of the deposition device 18 over any region above a build platform 24. As illustrated in FIG. 4, in one embodiment the deposition device 18 may be a multi-material dispensing rake 18.

The build platform 24 broadly comprises a horizontal build plate 26 or base plate and at least one vertical wall surrounding the build plate 26. In one preferred embodiment the build plate 26 sits on top of a rectangular, horizontal elevator plate 28, where four vertical walls 30 enclose the elevator plate 28, as illustrated in FIG. 1. The elevator plate 28 is vertically movable using actuators 20 (such as the first actuator above), where the elevator plate 28 is vertically movable relative to the four vertical walls 30.

The directed energy source 32 may be any kind as is known in the art including but not limited to a laser, electron beam, or other source of directed energy. The energy source 32 may be movably attached to a track 34 such that the energy source 32 can move anywhere in the three-dimensional space above the build platform 24. In one embodiment, the energy source 32 may be movable within a two-dimensional plane parallel to and above the build platform 24. The energy source 32 may also be movable such that it can direct its energy in any direction or angle relative to the plane parallel to the build platform 24. The movement, position, and direction of the energy source 32 may be manually controlled or caused by one or more of the actuators 20 of the types described above (such as the second actuator above). The actuators 20 of the directed energy source 32 may be controlled by the controller 36.

The controller 36 may comprise any number of combination of controllers, circuits, integrated circuits, programmable logic devices such as programmable logic controllers (PLC) or motion programmable logic controllers (MPLC), computers, processors, microcontrollers, transmitters, receivers, other electrical and computing devices, and/or residential or external memory for storing data and other information accessed and/or generated by the apparatus 12. The controller 36 may control operational sequences, power, speed, motion, or movement of the actuators 20 and/or temperature of the directed energy source 32.

The controller 36 may be configured to implement any combination of algorithms, subroutines, computer programs, or code corresponding to method steps and functions described herein. The controller 36 and computer programs described herein are merely examples of computer equipment and programs that may be used to implement the present invention and may be replaced with or supplemented with other controllers and computer programs without departing from the scope of the present invention. While certain features are described as residing in the controller 36, the invention is not so limited, and those features may be implemented elsewhere. For example, databases may be accessed by the controller 36 for retrieving CAD data or other operational data without departing from the scope of the invention.

The controller 36 may implement the computer programs and/or code segments to perform various method steps described herein. The computer programs may comprise an ordered listing of executable instructions for implementing logical functions in the controller 36. The computer programs can be embodied in any computer-readable medium for use by or in connection with an instruction execution system, apparatus, or device, and execute the instructions. In the context of this application, a “computer-readable medium” can be any physical medium that can contain, store, communicate, propagate, or transport the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), a portable compact disk read-only memory (CDROM), an optical fiber, multi-media card (MMC), reduced-size multi-media card (RS MMC), secure digital (SD) cards such as microSD or miniSD, and a subscriber identity module (SIM) card.

The residential or external memory may be integral with the controller 36, stand alone memory, or a combination of both. The memory may include, for example, removable and non removable memory elements such as RAM, ROM, flash, magnetic, optical, USB memory devices, MMC cards, RS MMC cards, SD cards such as microSD or miniSD, SIM cards, and/or other memory elements. As illustrated in FIG. 1, electrical conduits 38 and/or communication conduits 38 may also provide electrical power to the actuators 20, the powder hopper 16, the deposition device 18, the nozzles or nozzle solenoids, the build platform 24, and/or the directed energy source 32. Additionally or alternatively, the conduits 38 may be configured to provide communication links between the controller 36 and any of the actuators 20, the powder hopper 16, the deposition device 18, the nozzles or nozzle solenoids, the build platform 24, and the directed energy source 32.

In use, the additive manufacturing apparatus 12 may selectively deposit both the build powder 14 and the surrogate powder 10 using the deposition device 18 and selectively melt the build powder 14 using the directed energy source 32 to form a component 40, layer by layer. Specifically, the depositing and melting steps are repeated one or more times, until the component 40 is complete. The surrogate powder 10 is then removed and may be used again in another additive manufacturing process. The surrogate powder 10 provides structural support to the component 40 during additive manufacturing, helps reduce waste of the build powder 14, and allows for efficiently recycling of unused powder.

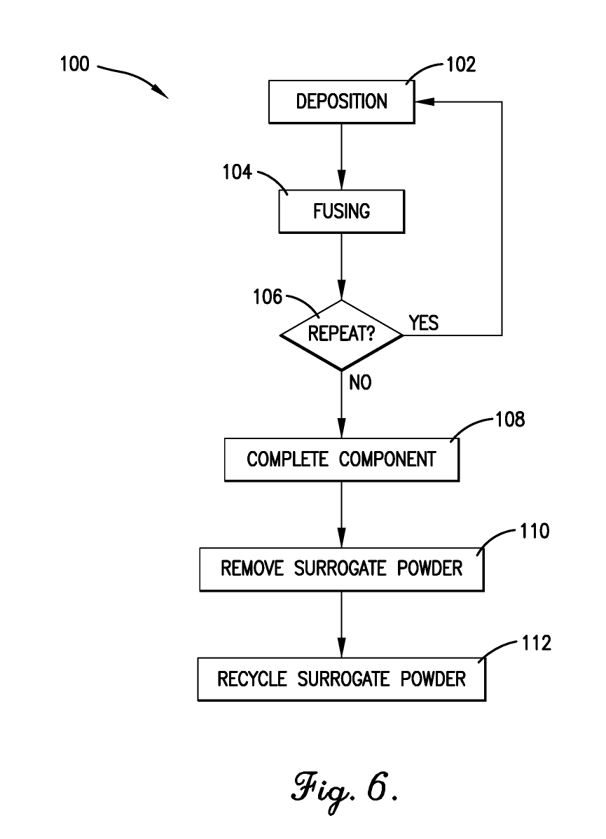

The flow chart of FIG. 6 depicts the steps of an exemplary method 100 for additive manufacturing the component 40 using the surrogate powder 10 to provide structural support during formation of the component 40. In some alternative implementations, the functions noted in the various blocks may occur out of the order depicted in FIG. 6. For example, two blocks shown in succession in FIG. 6 may in fact be executed substantially concurrently, or the blocks may sometimes be executed in the reverse order depending upon the functionality involved. Some or all of the steps described below and illustrated in FIG. 6 may also represent executable code segments stored on the computer-readable medium described above and/or executable by the controller 36.

The method 100 may comprise a step of selectively depositing different types of powder on the build platform 24, as shown in block 102, including the surrogate powder 10 and build powder 14. The build powder 14 may be used to build the component 40 and is placed in various regions on the build platform 24. The surrogate powder 10 may be deposited in regions where the build powder 14 has not been placed. This forms one layer of the component 40 in powder form on the build platform 24. Additionally or alternatively, this may form one layer of a plurality of components in powder form on the build platform 24 simultaneously, as illustrated in FIGS. 1-5.

The depositing of the different types of powders can be done in any order, including but not limited to placing each type of powder separately or placing both types at once as the deposition device 18 moves in any direction along the plane of the build platform 24. The build powder 14 and surrogate powder 10 may be deposited in separate regions forming the first layer in powder form. The build powder 14 may be partially or completely surrounded by the surrogate powder 10, the surrogate powder 10 being useful for lateral support during the additive manufacturing process. Further, the surrogate powder 10 may be deposited in a region partially or completely surrounded by the build powder 14, the surrogate powder 10 being useful for lateral and vertical support during the additive manufacturing process. The placement of the various regions of the different types of powder in the one layer, or location of these regions' deposition on the build platform 24, may be according to computer-aided design (CAD) data, or other technical model or drawing, as followed manually by a user or as directed in an automated or semi-automated fashion via control signals provided from the controller 36 to the deposition device 18 and its associated actuators 20 (such as the third actuator).

Next, the method 100 may include a step of tracing over the build powder 14 with the directed energy source 32, fusing the first layer of the component 40, as depicted in block 104. Specifically, after the first layer of powder has been deposited on the build platform 24, the directed energy source 32 may be selectively actuated to travel over the build powder regions and/or may be selectively turned on and off, thus melting the build powder 14 only in the regions exclusively containing build powder 14. For example, a laser beam emitted from the directed energy source 32 may be directed to trace or travel over/through the build powder 14 and its corresponding regions on the build platform 24. The tracing of the energy source 32 can be done according to CAD data, models, drawings, or other technical resources. The tracing of the energy source 32 over the build powder 14 causes the powder to fuse together, forming one layer of the component 40 in solid form. The energy source 32 may be configured and/or instructed to not trace over the surrogate powder 10. Additionally or alternatively, the energy source 32 may be configured to output heat that is high enough to fuse the build powder 14 together but not high enough to cause the surrogate powder 10 to fuse with itself, the build powder 14, or the component 40.

Then the method 100 may comprise repeating the steps 102 and 104 one or more times, as depicted in block 106, until the component 40 is complete, as depicted in block 108. Specifically, once one layer of the component 40 has been fused, a next layer of powder can be deposited. This is may be accomplished through first lowering the build platform 24 relative to the energy source 32 or deposition device 18. The lowering may also comprise lowering the base or build plate 26 relative to the walls 30. Once the lowering has occurred, the process may repeat in that the next layer of powder may be deposited onto a previous layer of the component 40. This deposition may also include the use of surrogate powder 10 or build powder 14 in the same way as in step 102. During the fusing step 104, the build powder 14 fuses together and also fuses to adjacent previous layers of the component 40. When subsequent layers are fused to the component 40, the surrogate powder 10 may act as lateral support to layers of the build material adjacent to the surrogate powder 10. The surrogate powder 10 may also serve as vertical support for layers of build powder 14 that may have been deposited on top of surrogate powder 10 layers during manufacturing of subsequent layers. This process may produce a single component 40, or a plurality of components 40 manufactured simultaneously.

Next, the method 100 may include the steps of removing the surrogate powder 10 from the component and/or build platform, as depicted in block 110, and recycling the removed powder for use in subsequent additive manufacturing, as depicted in block 112. Because the surrogate powder 10 was not fused to the component 40 or to itself, it is easily removed from any orifices or crevices of the component 40 or components 40. Further, because the surrogate powder 10 remains in powder form, it can easily be recycled for use in a subsequent additive manufacturing of another component, or set of components. This reduces the waste of build powder 14, while also increasing the efficiency in recycling used powder in additive manufacturing.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A method of additive manufacturing comprising:
(a) selectively depositing different types of powder in regions on a build platform, wherein
the different types of powder comprise at least a build powder and a surrogate powder, and
the regions of the build powder are separate from the regions of the surrogate powder;
(b) selectively melting only the build powder, without fusing any surrogate powder, by tracing an energy source over the regions on the build platform having the build powder deposited thereon, thereby forming a layer of the component;
(c) repeating, one or more times, both the depositing of step (a) on top of the layer of the component previously formed and the melting of step (b), thus sequentially forming and fusing a plurality of layers of a component together; and
(d) removing the surrogate powder from the component and the build platform.

2. The method of claim 1, wherein step (a) comprises depositing the different types of powder according to a computer-aided design (CAD) model or other technical drawing or model.

3. The method of claim 1, wherein step (c) comprises sequentially forming the component according to a CAD model or other technical drawing or model.

4. The method of claim 1, further comprising recycling the surrogate powder removed from the component and the build platform.

5. The method of claim 4, further comprising reusing the surrogate powder removed from the component and build platform in another additive manufacturing process.

6. The method of claim 1, wherein step (c) further comprises lowering the build platform before each repetition of steps (a) and (b).

7. The method of claim 1, wherein the build platform comprises a base enclosed by at least one wall.

8. The method of claim 7, wherein step (c) further comprises lowering the base relative to the at least one wall before each repetition of steps (a) and (b).

9. The method of claim 1, wherein the build platform lowers relative to the energy source.

10. The method of claim 1, wherein the different types of powder comprises metals, metal alloys, stainless steel, ceramics, plastics, silicon, or a combination thereof, in powder form.

11. The method of claim 1, wherein the energy source is a laser or electron beam.

12. The method of claim 1, wherein the component comprises a plurality of components simultaneously fabricated on the build platform.

13. The method of claim 12, wherein the regions of the surrogate powder completely surround the regions of the build powder in step (a) to provide structural support during steps (b) and (c).

14. The method of claim 1, wherein the surrogate powder completely surrounds the regions of the build powder regions in step (a) to provide structural support during additive manufacturing.

15. The method of claim 1, wherein the surrogate powder comprises casting sand.

16. A method of additive manufacturing comprising:
(a) selectively depositing different types of powder in different regions on a build platform according to a computer-aided design (CAD) model of a component, wherein
the different types of powder comprise at least a build powder and a surrogate powder,
the regions of the build powder are separate from the regions of the surrogate powder,
the regions of the surrogate powder completely surround the regions of the build powder covering all area outside the regions of the build powder on the build platform, and
the build platform comprises a base enclosed by at least one wall;
(b) selectively melting only the build powder, without fusing any surrogate powder, by tracing an energy source over the regions on the build platform having the build powder deposited thereon according to the CAD model, thereby forming a layer of the component;
(c) lowering the build platform relative to the at least one wall;
(d) repeating, one or more times, the depositing of step (a) on top of the layer of the component previously formed, the melting of step (b), and the lowering of the build platform of step (c), thus sequentially forming and fusing a plurality of layers of the component together; and
(e) removing the surrogate powder from the component and build platform.

17. The method of claim 16, further comprising recycling the surrogate powder removed from the component and the build platform.

18. The method of claim 17, further comprising reusing the surrogate powder removed from the component and the build platform in another additive manufacturing process.

19. The method of claim 16, wherein a plurality of components are fabricated on the build platform at once.

20. An additive manufacturing apparatus comprising:
a build platform comprising a horizontally extending base and at least one vertically-extending wall surrounding the base;
a directed energy source;
a powder deposition device comprising:
at least two selectively openable chambers, wherein one of the chamber contains a surrogate powder and one of the chambers contains a build powder;
a first actuator configured to actuate the base relative to the wall along a center axis of the base,
a second actuator configured to actuate movement of the directed energy source relative to the build platform;
a third actuator configured to actuate movement of the at least a portion of the powder deposition device relative to the build platform; and
a controller communicably coupled with the powder deposition device, the directed energy source, the first actuator, the second actuator, and the third actuator, wherein the controller is configured to:
(a) command third actuator and the powder deposition device to selectively deposit the surrogate powder and the build powder in different regions on the build platform,
(b) command the directed energy source and the second actuator to selectively melt only the build powder on the build platform,
without fusing any surrogate powder, by tracing the directed energy source over the regions on the build platform having the build powder deposited thereon, thereby forming a layer of a component,
(c) command the first actuator to lower the build platform relative to the wall; and
(d) repeat, one or more times, the commanding of the selectively depositing of step (a) on top of the layer of the component previously formed, the selectively melting of step (b), and the lowering of the build platform of step (c) thus sequentially forming and fusing a plurality of layers of the component together.
